(19) United States
(12) Patent Application Publication
(10) Pub. No.: US 2006/0033677 A1
(43) Pub. Date: Feb. 16, 2006

(54) Display device

(76) Inventors: Kenneth Faase, Corvallis, OR (US); Paul J. Benning, Corvallis, OR (US); James C. McKinnell, Salem, OR (US); Paul F. Reboa, Corvallis, OR (US); Kevin F. Peters, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/990,389

(22) Filed: Nov. 17, 2004

Related U.S. Application Data
(63) Continuation-in-part of application No. 10/915,753, filed on Aug. 10, 2004.

(51) Int. Cl. G09G 3/00

(52) U.S. Cl. 345/30

(57) ABSTRACT

A light modulator includes a first enclosed portion that includes a first electrode within a light path, a first electrode outside the light path, and a first colorant in communication with the first electrode within the light path and the first electrode outside the light path. The first inner electrode, the first outer electrode and the first colorant is within the first enclosed portion and includes a device for moving the first colorant between a position within the light path and outside the light path.

### RELATED APPLICATION

This application is a continuation-in-part and claims priority of invention under 35 U.S.C. §120 from U.S. application Ser. No. 10/915,753, filed Aug. 10, 2004, which is incorporated herein by reference.

### BACKGROUND

In many displays, a color pixel includes at least three subpixels positioned in a plane. Each of the at least three subpixels corresponds to a different color positioned in at least three parallel light paths. In such a display, the array is size limited since each pixel includes at least three subpixels on a plane. Three subpixels for each pixel leads to larger arrays when an increased resolution is desired, due to limitations in the technology due to switching, Furthermore, in a display device having at least three planar subpixels per pixel, when a single primary color from one of the subpixels is to be transmitted, the light from the other two subpixels must be absorbed. Absorbing the other primary colors reduces the brightness and contrast of the display.

### BRIEF DESCRIPTION OF THE DRAWINGS

FIG. 1 is a schematic diagram of a display device, according to an example embodiment.

FIG. 2 is a side view of an enclosed portion of a cell of a display device in a first state, according to an example embodiment.

FIG. 3 is a top view of an enclosed portion of a cell of a display device in a first state along line 3-3 in FIG. 2, according to an example embodiment.

FIG. 4 is a side view of a cell of a display device in a second state, according to an example embodiment.

FIG. 5 is a top view of a cell of a display device in a second state, according to an example embodiment.

FIG. 6 is a schematic diagram of a cup of a chamber or enclosed portion with a layer of conductive material deposited on a major surface of the cup, according to an example embodiment.

FIG. 7 is a schematic diagram of a cup of a chamber or enclosed portion with a layer of photoresist covering the layer of conductive material deposited on a major surface of the cup, according to an example embodiment.

FIG. 8 is a schematic diagram of a cup of a chamber or enclosed portion with trenches formed in the layer of photoresist, according to an example embodiment.

FIG. 9 is a schematic diagram of a cup of a chamber or enclosed portion with trenches formed in the conductive layer, according to an example embodiment.

FIG. 10 is a schematic diagram of a cup of a chamber or enclosed portion with a trace and a via formed to electrically connect an inner electrode to the trace, according to an example embodiment.

FIG. 11 is a perspective view of a lid for a chamber or enclosure portion, according to an example embodiment.

FIG. 12 is a perspective view of a cup for a chamber or enclosure portion, according to an example embodiment.

FIG. 13 is a perspective view of a chamber or enclosure portion, according to an example embodiment.

FIG. 14 is a perspective view of a stack of a plurality of chamber or enclosure portions, according to an example embodiment.

FIG. 15 is a schematic diagram of a stack of chambers or enclosed portions, according to another example embodiment.

FIG. 16 is a schematic diagram of a stack of enclosed portions forming a cell of a spatial light generator of a display device, according to another example embodiment.

FIG. 17 is a schematic diagram of a stack of chambers or enclosed portions, according to an example embodiment.

FIG. 18 is a schematic diagram of a stack of enclosed portions forming a cell of a spatial light generator of a display device, according to an example embodiment.

FIG. 19 is a schematic diagram of a display device, according to another example embodiment.

FIG. 20 is a schematic diagram of a stack of chambers or enclosed portions, according to an example embodiment.

FIG. 21 is a schematic diagram of a stack of chambers or enclosed portions, according to an example embodiment.

FIG. 22 is a flow diagram of a method, according to an example embodiment.

### DETAILED DESCRIPTION

In the following description, the drawings illustrate specific example embodiments sufficiently to enable those skilled in the art to practice it. Other embodiments may incorporate structural, logical, electrical, process, and other changes. Examples merely typify possible variations. Individual components and functions are optional, and the sequence of operations may vary. Portions and features of some embodiments may be included in or substituted for those of others. The scope of the invention encompasses the full gambit of the claims and all available equivalents.

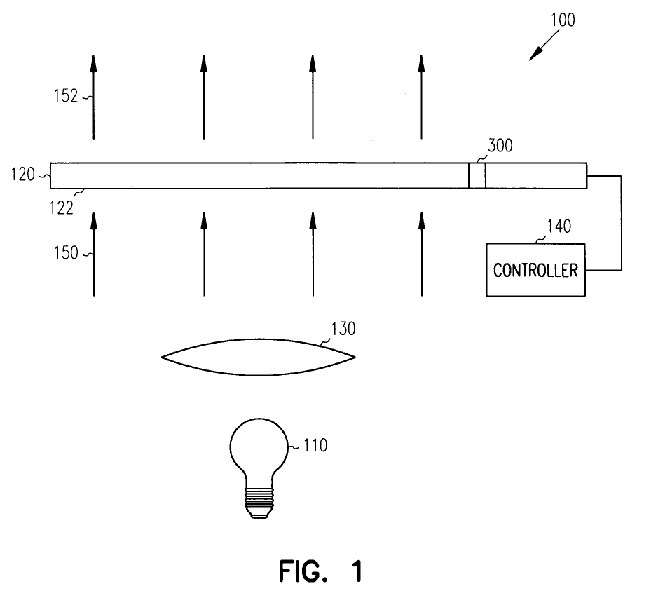

FIG. 1 is a schematic diagram of a display device 100, according to an example embodiment. The display device 100 includes a light source 110, a spatial light modulator 120, and optics 130 for directing light from the light source 110 toward the spatial light modulator 120. The spatial light modulator 120 includes a transmissive back plane 122. The spatial light modulator 120 includes at least one cell 300. The spatial light modulator 120 can include one cell or can include a plurality of cells. In some example embodiments, each of the cells 300 corresponds to a pixel on the display device 100. Attached to the spatial light modulator 120 is a controller 140. The controller 140 receives image information for the spatial light modulator 120 and controls the spatial light modulator 120 to produce an image or series of images. The controller 140 controls at least one cell 300 of the spatial light modulator 120. In another embodiment, the controller 140 controls a plurality or multiplicity of cells 300 associated with the spatial light modulator 120 in order to produce an image. In the embodiments where there are a plurality or multiplicity of cells or pixels 300, the cells or pixels 300 are individually connected to the controller 140. Each cell or pixel 300 can be individually addressed or controlled in order to produce a desired image. As shown in FIG. 1, white light, as depicted by reference numeral 150, is transmitted to the spatial light modulator 120, passes through the spatial light modulator 120 and exits as filtered light 152. The spatial light modulator 120 may be read directly, therefore be an active display or the display device 100 can be provided with a screen onto which the filtered light 152 is projected. In this latter embodiment, the display device is actually a projection device. The screen is not shown in FIG. 1.

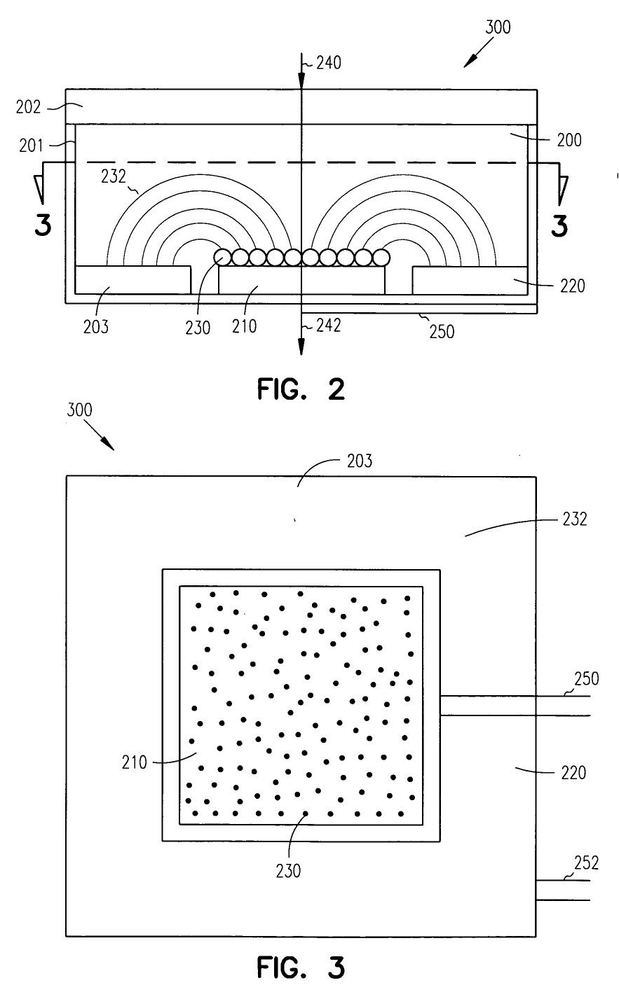

FIG. 2 is a side view of an enclosed portion 200 of a cell 300 of a display device 100 (shown in FIG. 1) in a first state, according to an example embodiment. FIG. 3 is a top view of the enclosed portion 200 of a cell 300 of a display device 100 (shown in FIG. 1) in a first state along line 3-3 in FIG. 2, according to an example embodiment. Now referring to both FIGS. 2 and 3, the first enclosed portion 200 or chamber of the cell 300 will be further detailed. The chamber or first enclosed portion 200 of the cell 300 of the spatial light modulator includes a cup 201 and a lid 202. The cup 201 includes a major surface 203 and a set of sidewalls attached to the major surface. A first inner electrode 210, and a first outer electrode 220 are positioned on the major surface 203 on the interior of the cup 201. The chamber or enclosed portion 200 is formed by attaching the lid 202 to the cup 201. The cup 201 and the lid 202 are translucent or transparent. Included within the chamber or enclosed portion 200 is a first colorant 230 and solvent 232. Colorant includes pigments, dyes, toners and the like. Colorant removes a portion of light and is not limited to light within the visible spectrum. The first colorant 230 and the first solvent 232 are within the chamber or enclosed portion 200 and are also in fluid communication with the first inner electrode 210 and the first outer electrode 220. The first inner electrode 210, the first outer electrode 220 and the first colorant 230 and other molecules or atoms are within the chamber or the first enclosed portion 200 of the cell 300. Although a first colorant 230 and a first solvent 232 are described with respect to FIG. 2, other embodiments include the use of a first colorant as a dyed oil within water (electrowetting or surface energy differences) or the first colorant as a gas with toner within the chamber (electrostatics).

As shown in FIGS. 2 and 3, the first inner electrode 210 is square-shaped and the first outer electrode 220 is also square-shaped with a cut-out for the inner electrode 210. The outer electrode 220, therefore, is positioned about the periphery of the inner electrode 210. The spacing between the inner electrode 210 and the outer electrode 220 is sufficient to prevent the charge placed on either the inner electrode 210 or the outer electrode 220 from migrating to the other of the inner electrode 210 or the outer electrode 220. Of course, the inner electrode 210 and the outer electrode 220 are not limited to a square shape, but can be of any shape.

The fluid within the chamber or first enclosed portion 200 can be either a liquid or a gas. Of course, the chamber or enclosed portion 200 is substantially sealed to prevent leakage of fluids from the chamber or enclosed portion 200. The first colorant 230 is also liquid, solid or gas. In some embodiments, the first colorant 230 is a separate molecule. In other embodiments, the first colorant 230 includes a dyed portion of a liquid, solid or gas. The first colorant 230 can be associated with a polarized molecule or atom. In addition to the colorant, the chamber or enclosed portion 200 of the cell 300 also includes a transparent or translucent fluid, such as a gas or liquid.

The chamber or enclosed portion spatial light modulator also includes a device for moving the first colorant between the first inner electrode 210 and the first outer electrode 210 The device for moving the first colorant modulates the first colorant between a position on the first outer electrode 220 and the first inner electrode 210. An electrical trace or set of electrical traces or conductor 250 connects the inner electrode 210 to the controller 140 (shown in FIG. 1). Another set of electrical traces or a conductor 252 connects the outer electrode 220 to the controller 140 (shown in FIG. 1). The controller 140 controls the charge carried by the inner electrode 210 and the charge carried by the outer electrode 220 to move the colorant between a position in a light path 240 and a position outside the light path 240. The light path 240 is depicted by an arrow carrying the reference number 240. As shown in FIGS. 2 and 3, the light path passes through the inner electrode 210. In FIGS. 2 and 3, the first colorant 230 or molecules or ions associated with the first colorant 230 is positioned on the first inner electrode 210 in the light path 240. When light on the light path 240 passes through the first colorant 230, the output from the chamber or enclosed portion is filtered, as depicted by an arrow with a reference number 242. In other embodiments, the light path can pass through other portions of the chamber or enclosed portion 200.

Several types of systems can be used within the chamber or enclosed portion 200 to move the first colorant 230 between a position within a light path 240 and a position outside the light path 240. The type of systems include electrostatics (gas or vacuum with or without solid toner particles), electrophoresis (fluid solvent), or electrowetting (dyed oil and water). For example, electrostatics is concerned with the effects of positive and negative charges. The fundamental charges are the electron and the proton. Two electric charges attract or repel each other with a force that is proportional to the product of the charges and that varies inversely with the square of the distance between them. The charges on particles can be used to move the particles. As illustrated in FIGS. 2 and 3, the first colorant 230 is comprised of negatively charged particles. When the inner electrode 210 is provided with a positive charge, the negatively charged particles of first colorant 230 migrate and attach to the inner electrode 210. Of course, in another embodiment, the first colorant 230 can be positively charged particles and the first inner electrode 210 can be provided with a negative charge.

Another example system includes electrophoresis. Electrophoresis is concerned with the migration of charged particles in an electric field and is a method for separating such particles. Charged particles associated with the first colorant 230 can be within a fluid solvent. The electric field caused by charging the first inner electrode 210 with a negative charge and the first outer electrode 220 with a positive charge will result in the first colorant 230 being positioned in the light path 240. The fluid solvent can be any type of liquid, including a gel or other inert polymer network.

Still another example system uses electrowetting. In an electrowetting system, the first colorant 230 is in the form of a dye. The system includes water and oil which are immiscible. The water molecule is polar such that charging one of the first inner electrode 210 or the first outer electrode attracts the water. The water can be provide with a dye so that the dye or first colorant moves with the water. In an alternative embodiment, the oil is dyed. Moving the water then concentrates the first colorant since the water displaces the oil and moves the oil into and out of the light path 210.

FIGS. 2 and 3 show the colorant or dye carrying portion positioned within the light path 240. Light on the light path 240 is filtered by the first colorant 230.

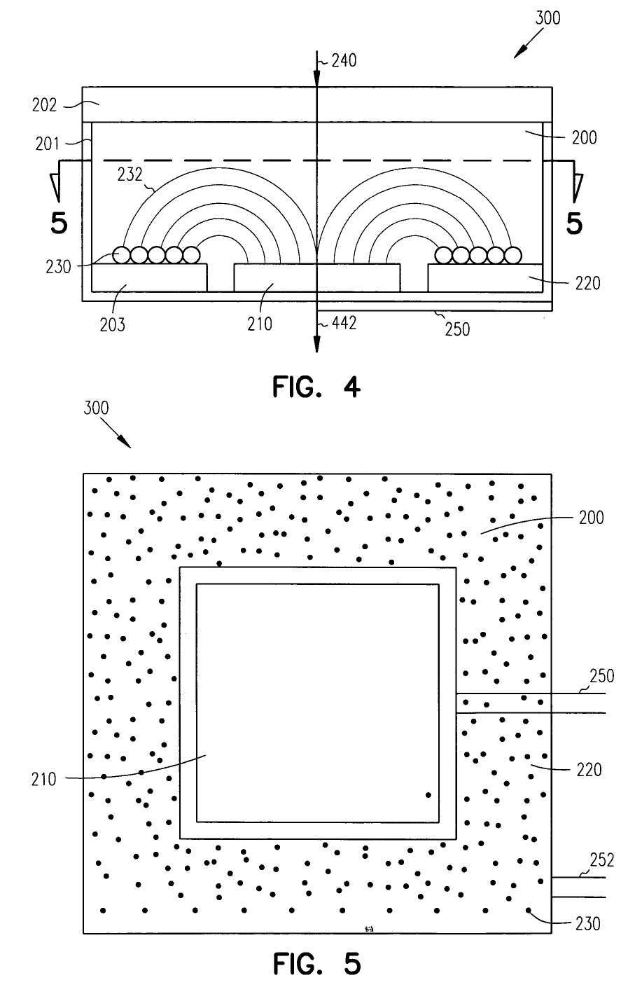

FIG. 4 is a side view of an enclosed portion 200 of a cell 300 of a display device 100 (shown in FIG. 1) in a second state, according to an example embodiment. FIG. 5 is a top view of a cell an enclosed portion 200 of a cell 300 of a display device 100 (shown in FIG. 1) in a second state, along line 5-5 in FIG. 4, according to an example embodiment. Now turning to both FIGS. 4 and 5, the chamber or the enclosed portion 200 in a second state will be further discussed. The structure of the chamber 200 of the cell 300 shown in FIGS. 4 and 5 is the same as the structure shown in FIGS. 2 and 3. Therefore, the discussion of FIGS. 4 and 5 will discuss some of the differences between FIGS. 4 and 5, and FIGS. 2 and 3. One of the differences is that the first colorant 230 is now positioned on the first outer electrode 220. The electrical charge on the first inner electrode 210 in the second state shown in FIGS. 4 and 5 is opposite or neutral when compared to the electrical charge on the first inner electrode 210 in the first state shown in FIGS. 2 and 3. As a result, the particles associated with the first colorant 230 are either unattracted to the first inner electrode 210 or are repelled by the first inner electrode 210. The electrical charge on the first outer electrode 220 in the second state shown in FIGS. 4 and 5 is selected to attract the particles or molecules associated with the first colorant 230. Therefore, the electrical charge on the first outer electrode 220 in the second state shown in FIGS. 4 and 5, is similar to or substantially the same as the electrical charge on the first inner electrode 210 in the first state shown in FIGS. 2 and 3. As a result, the colorant 230 is moved to a position outside the light path 240 so that light from the light path 240 is transmitted through the chamber or enclosed portion 200 and output from the chamber or enclosed portion 200 substantially unfiltered, as depicted by arrow 442.

The chamber or enclosed portion 200 is electrically connected to the controller 140 (shown in FIG. 1). Controlling the electrical charge on the first inner electrode 210 and the first outer electrode 220 moves the colorant 230 between the first inner electrode 210 and the first outer electrode 220. Changing the electrical charges is done in response to inputs to the controller 140 (shown in FIG. 1) resulting from image data. The controller 140 (shown in FIG. 1) includes a voltage source, a first inner electrode electrical path 250 to the first inner electrode 210, a first outer electrode electrical path 252 to the first outer electrode 220, and an apparatus for attaching one of the first inner electrode 210 or the first outer electrode 220 to the voltage source.

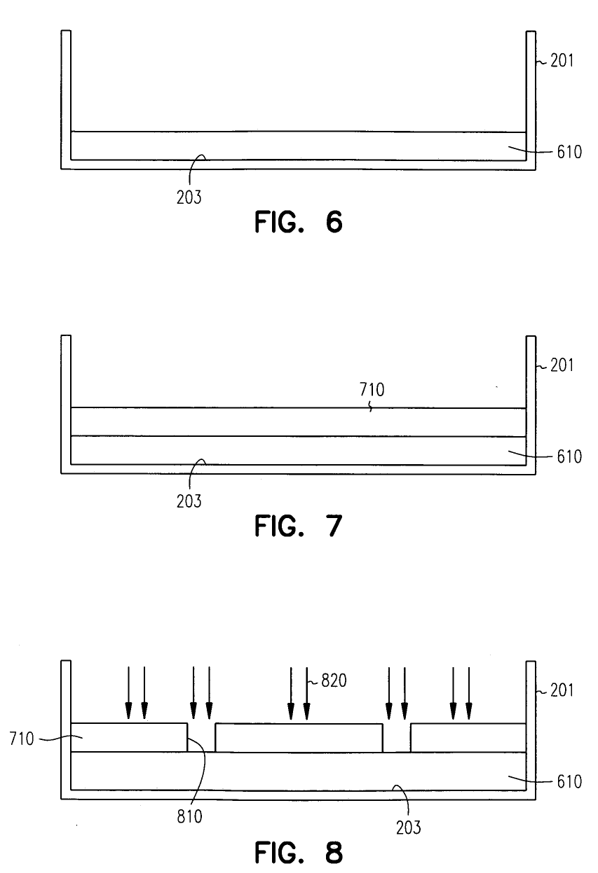

Now turning to FIGS. 6-10, the making of the cup 201 of the chamber or first enclosed portion 200 (shown in FIGS. 2-5) will now be detailed. The chamber or first enclosed portion 200 is formed from a cup 201 and a lid 202 (shown in FIGS. 2-5). The cup 201 includes the major surface 203 in the interior of the cup 201. As shown in FIG. 6, a translucent or transparent layer of conductive material 610 is deposited on the major surface 203. A layer of photoresist 710 is deposited on the conductive layer, as shown in FIG. 7. The photoresist layer 710 is patterned and a trench 810 is formed within the photoresist layer 710. In one embodiment, the trench is a square. The trench is then exposed to selective etching process. The etching process may be a wet etch or a dry etch. The etching process, depicted by arrows 820 removes the conductive material 610 below the trench 810. Substantially all the conductive material 610 below the trench 810 is removed by the etching process. Once the etching process is complete, the remaining photoresist layer 710 is removed.

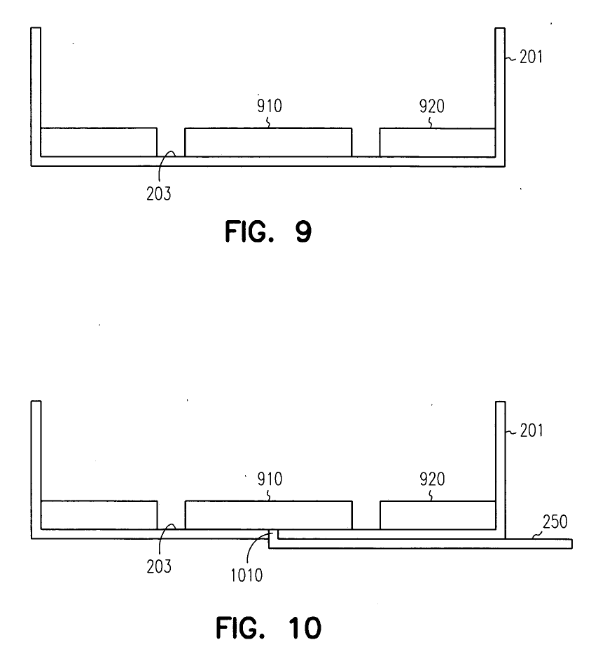

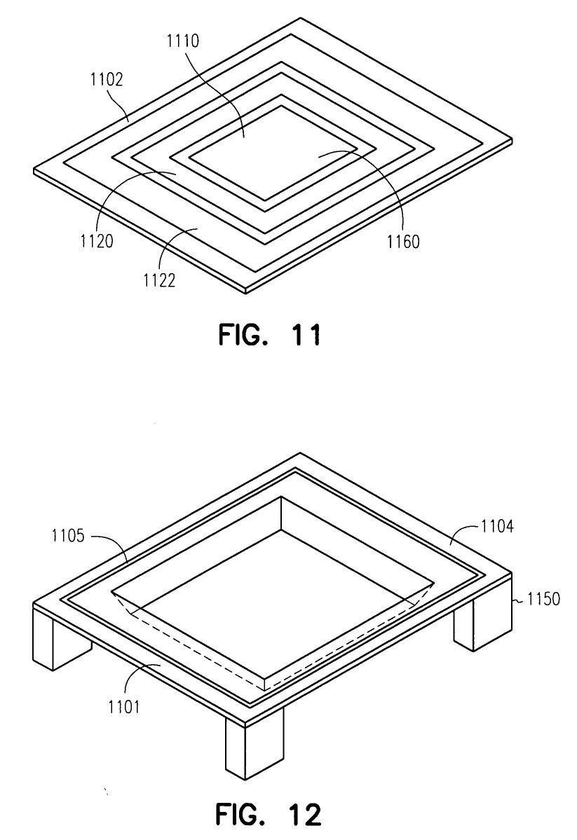

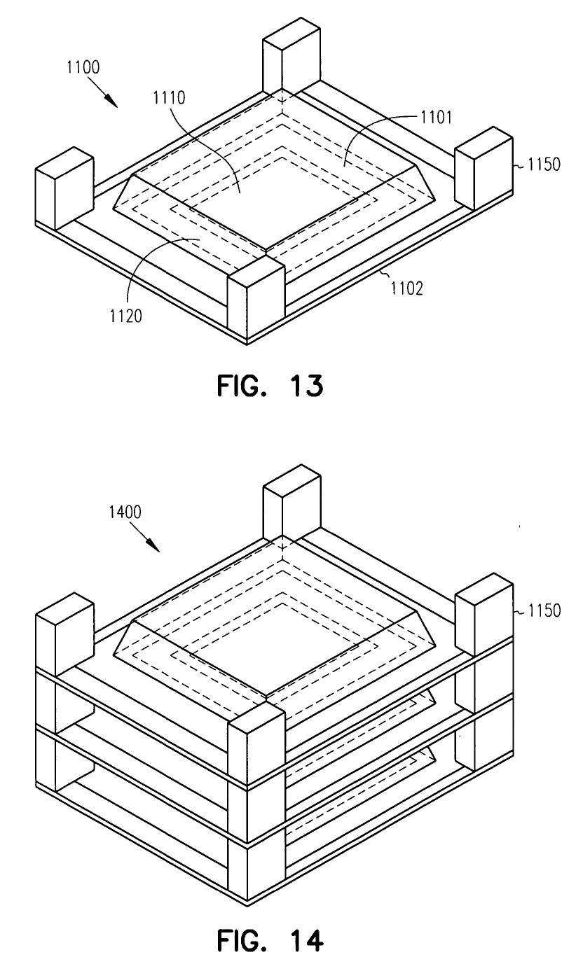

FIG. 9 shows a cross sectional view of the cup 201 after the photoresist is removed. The cup 201 includes an inner electrode 910 and an outer electrode 920 positioned on the major surface 203 of the cup 201. As shown in FIG. 10, a trace 250 is formed on the bottom of the cup 201 and a via 1010 is formed to electrically connect the trace to the inner electrode 910. The via 1010 is filled with a conductor so that the cup 201 can be sealed by placing the lid 202 on the cup 201 to form a chamber or enclosed portion, such as enclosed portion 200 shown in FIGS. 2-5. Although not shown, another trace and electrical connection can be formed in a similar manner to provide an electrical connection of the outer electrode 920.

To form the chamber or enclosed portion 200, the appropriate fluids, solvents, dyes or colorants, in gaseous or liquid state, are added to the cups 201. The lid or cover 202 is attached to the cup 201 to form the chamber or enclosed portion 200. Enclosed portions or chambers 200 are available from SiPix Imaging, Inc. of Milpitas, Calif. The enclosed portions or chambers 200 available from SiPix are not patterned as discussed above. The enclosed portions or chambers available from SiPix Imaging, Inc., generally include a plurality of chambers positioned in a horizontal plane of material that have to be diced to form individual chambers.

FIGS. 11-13 show an alternative embodiment for making the chamber or enclosed portion 1100 having a lid 1102 and a cup 1101. In this alternative embodiment, a conductive metal 1160 is deposited on one side of the lid 1102. Photolithography and etching techniques similar to the ones discussed above are used to form an inner electrode 1110, an outer electrode 1120, and a peripheral seal 1122. Formed on the opposite side of the lid are the electrical traces and vias that provide electrical communication to the inner electrode 1110 and the outer electrode 1120. The cup 1101 includes a lip 1104. On the lip 1104 of the cup 1101 is formed another seal 1105 of the same or similar material that forms the seal 1122 on the lid 1102. The lip 1104 also includes towers, such as tower 1150. The cup 1101 is then filled with colorant and solvent. The lid 1102 is then attached to the cup 1101 so that the seal 1122 of the lid 1102 and the seal 1105 of the cup 1101 can be bonded together. In one embodiment, a frit bond is formed between the cup 1101 and the lid 1102. The inner electrode 1110 and the outer electrode 1120 are then also within the chamber or enclosed portion 1100 along with the colorant or dye and the other fluid, depending on which type of system is used (electrophoresis, electrostatics or electowetting). As shown in FIG. 13, the resultant chamber or enclosed portion 1100 is then flipped.

FIG. 14 shows a stack 1400 of several chambers or enclosed portions, according to an example embodiment. Posts 1150 are used to attach one chamber or enclosed portion to another a chamber or enclosed portion. As shown in FIG. 14, the stack 1400 includes three layers of chambers or enclosed portions. In some embodiments, the three chambers or enclosed portions each contain colorant or dye of a different color. In one embodiment, the three chambers include cyan, yellow and magenta colorants.

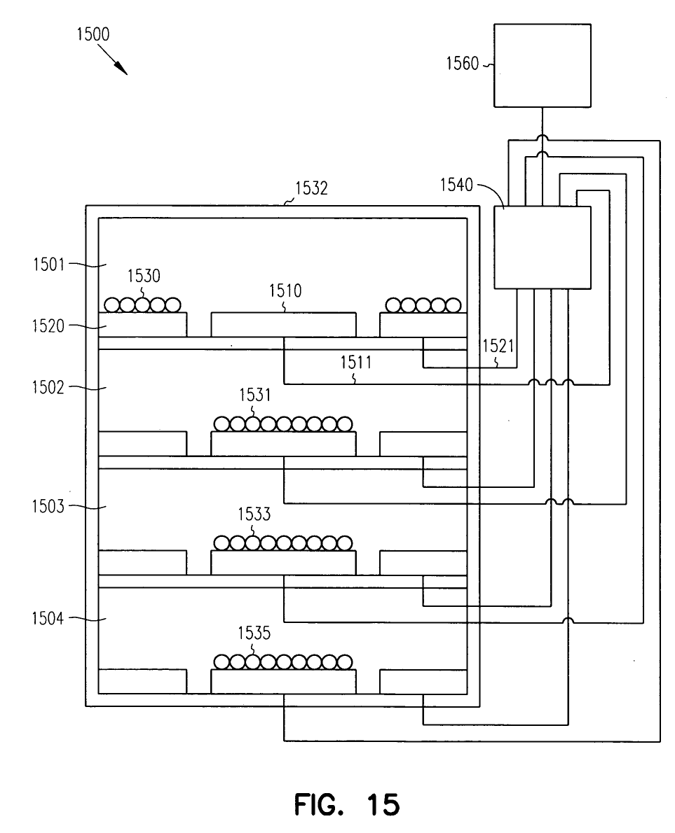

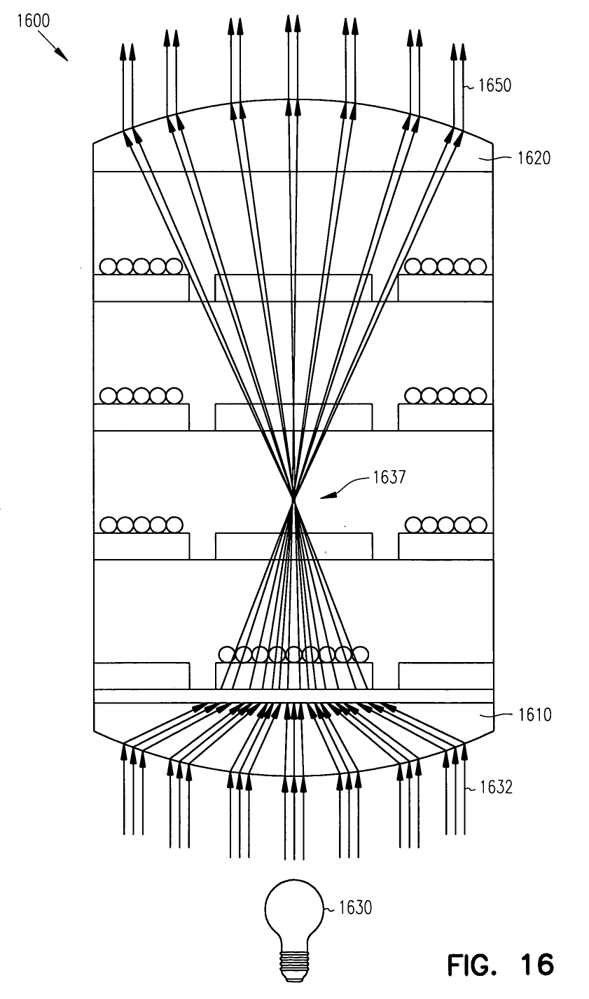

FIG. 15 is a schematic diagram of a stack 1500 of chambers or enclosed portions 1501, 1502, 1503, 1504, according to an example embodiment. Each of the chambers or enclosed portions 1501, 1502, 1503, 1504 has substantially the same structure. As a result, rather than be repetitive, one of the chambers or enclosed portions 1501 will be described from a structural standpoint for the sake of clarity. Chamber or enclosed portion 1501 includes an inner electrode 1510 and an outer electrode 1520. The chamber 1501 also includes an electrical trace or conductor 1511 for electrically connecting the inner electrode 1510 to a controller 1540. The chamber 1501 also includes an electrical trace or conductor 1521 for electrically connecting the outer electrode 1520 to a controller 1540. The chamber or enclosed portion 1501 also includes a fluid that includes both a transparent or translucent portion 1532 and a colorant or dye 1530. The controller 1540 controls the charge on both the inner electrode 1510 and the outer electrode 1520. This in turn controls the position of the colorant or dye 1530. As shown in chamber or enclosed portion 1501 in FIG. 15, the controller 1540 is controlling the voltage on the inner electrode 1510 and on the outer electrode 1520 so that the colorant 1530 is positioned on the outer electrode 1520.

Each of the chambers or enclosed portions 1501, 1502, 1503, 1504 includes a dye or colorant 1530, 1531, 1533, 1535, respectively. In one embodiment, the difference is that each of the chambers or enclosed portions 1501, 1502, 1503, 1504 includes a colorant, such as a pigment or dye, 1530, 1531, 1533, 1535 of a different color. In addition, the position of the colorant or dye 1530, 1531, 1533, 1535 within each of the chambers or enclosed portions 1501, 1502, 1503, 1504, respectively, is independently controllable by the controller 1540. In other words, the controller 1540 can be used to control the location of the colorant 1530, 1531, 1533, 1535 separately in each of the respective chambers or enclosed portions 1501, 1502, 1503, 1504. The controller 1540 can move any combination of the colorants 1530, 1531, 1533, 1535 into a light path to produce filtered light of a selected color. The controller 1540 will act in response to image data or image signals to control the movement of the colorant or dye 1530, 1531, 1533, 1535 within the respective chamber or enclosed portion 1501, 1502, 1503, 1504. The controller 1540 will selectively move the colorant or dye 1530, 1531, 1533, 1535 in each of the chambers or enclosed portions 1501, 1502, 1503, 1504 to produce filtered light of a particular color. In one embodiment, each of the chambers or enclosed portions 1501, 1502, 1503, 1504 include a different color. In one example embodiment, the first color, the second color, the third color and the fourth color associated with the chambers or enclosed portions 1501, 1502, 1503, 1504 include cyan, yellow, magenta, and black.

FIG. 16 is a schematic diagram of a stack of enclosed portions forming a cell 1600 of a spatial light generator of a display device 100 (shown in FIG. 1), according to another example embodiment. The cell 1600 includes a stack 1500 of chambers or enclosure portions. The cell 1600 also includes a first lens 1610 on the end of the stack 1500 and a second lens 1620 on the other end of the stack 1500. In one embodiment, the lens 1610 is a micro lens array that includes transparent traces and transparent transistor logic. Lens 1620 is a similar micro lens array. Light from a light source 1630, is directed along a plurality of light paths, such as light path 1632, through the stack 1500 of chambers or enclosure portions. The lens 1630 can be used to change a focal point 1637 of the various light paths, such as light path 1632. The controller 1540 (shown in FIG. 15) acts upon image data and signals to move the different colored colorants within the different cells into and out of the light paths, such as light path 1632. The focal point can be changed to vary the amount of colorant used to filter the light along a light path. As shown in FIG. 16, the focal point is placed near an inner electrode that allows the light to pass through the chamber or enclosure portion without moving a colorant into the light path. The light passing through the cell 1600 then exits from the cell as filtered light 1650 or in some instances, unfiltered light.

Referring now to FIGS. 1, 15 and 16, a display device 100 includes a plurality of display elements, such as cell 1600, capable of controlling light within a visible light spectrum. The plurality of display elements, such as cell 1600, are positioned over a display surface of the display. The source of light 1630 produces a light path, such as light path 1632. At least some of the display elements, such as cell 1600, include a first chamber 1501 and a second chamber 1502. The first chamber 1501 further includes a first colorant 1530, and an apparatus for controlling the position of the first colorant with respect to the light path 1540. The second chamber 1502 includes a second colorant 1531, and an apparatus for controlling the position of the second colorant with respect to the light path 1540. The light path passes through the first chamber 1501 and the second chamber 1502. The first chamber 1501 is in an adjacent plane with respect to the second chamber 1502. The display 100 also includes a plurality of receivers, such as receiver 1560, coupled to the plurality of display elements and adapted to receive transmitted image information and activate the display elements in response to the image information. The display further includes an apparatus for controlling the first chamber 1501 and the second chamber 1502. The apparatus controls at least some of the chambers 1501, 1502 in at least one of the display elements, such as cell 1600, in response to image information received at the receivers. The display further includes a third chamber 1503 having a third colorant 1533, and an apparatus for controlling the position of the third colorant 1533 with respect to the light path 1632. The display 100 also includes a fourth chamber 1504 further including a fourth colorant 1535, and an apparatus for controlling the position of the fourth colorant 1535 with respect to the light path 1632. In some embodiments, the first chamber 1501, the second chamber 1502, the third chamber 1503 and the fourth chamber 1504 are stacked with respect to one another. The display 100 includes a plurality of receivers coupled to the plurality of display elements. The receivers are adapted to receive transmitted image information and activate the display elements in response to the image information. At least one receiver includes control lines for controlling the first position of the first colorant 1530, for controlling the position of the second colorant 1531, for controlling the third colorant 1533, and for controlling the fourth colorant 1534 in response to image information received at the at least one receiver.

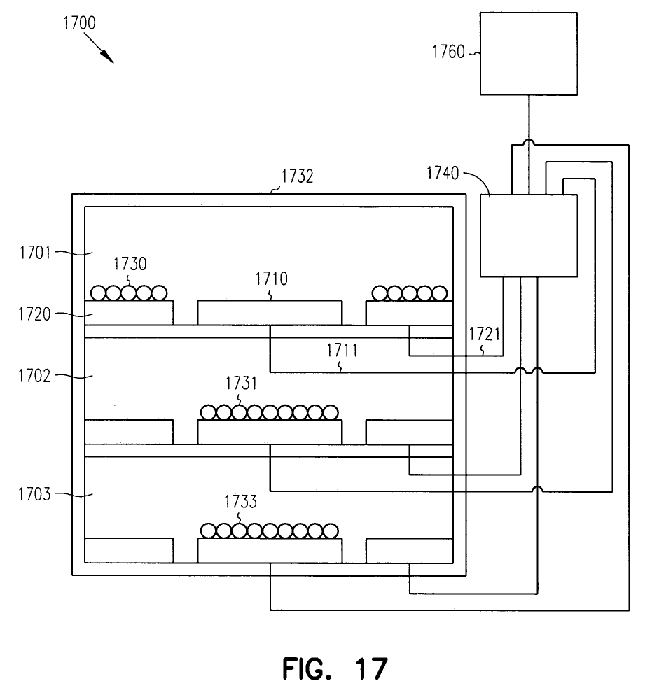

FIG. 17 is a schematic diagram of a stack 1700 of chambers or enclosed portions 1701, 1702, 1703, according to an example embodiment. Each of the chambers or enclosed portions 1701, 1702, 1703 has substantially the same structure. As a result, rather than be repetitive, one of the chambers or enclosed portions 1701 will be described from a structural standpoint for the sake of clarity. Chamber or enclosed portion 1701 includes an inner electrode 1710 and an outer electrode 1720. The inner electrode is an electrode that is positioned in a light path. The outer electrode is an electrode within the chamber that is outside the light path. The chamber 1701 also includes an electrical trace or conductor 1711 for electrically connecting the inner electrode 1710 to a controller 1740. The chamber 1701 also includes an electrical trace or conductor 1721 for electrically connecting the outer electrode 1720 to a controller 1740. The chamber or enclosed portion 1701 also includes a fluid that includes both a transparent or translucent portion 1732 and a colorant or dye 1730. The controller 1740 controls the charge on both the inner electrode 1710 and the outer electrode 1720. This in turn controls the position of the colorant or dye 1730. As shown in chamber or enclosed portion 1701 in FIG. 17, the controller 1740 is controlling the voltage on the inner electrode 1710 and on the outer electrode 1720 so that the colorant 1730 is positioned on the outer electrode 1720.

Each of the chambers or enclosed portions 1701, 1702, 1703 includes a dye or colorant 1730, 1731, 1733, respectively. In one embodiment, the difference is that each of the chambers or enclosed portions 1701, 1702, 1703 includes a colorant, such as a pigment or dye, 1730, 1731, 1733 of a different color. In addition, the position of the colorant or dye 1730, 1731, 1733 within each of the chambers or enclosed portions 1701, 1702, 1703, respectively, is independently controllable by the controller 1740. In other words, the controller 1740 can be used to control the location of the colorant 1730, 1731, 1733 separately in each of the respective chambers or enclosed portions 1701, 1702, 1703. The controller 1740 can move any combination of the colorants 1730, 1731, 1733 into a light path to produce filtered light of a selected color. The controller 1740 will act in response to image data or image signals to control the movement of the colorant or dye 1730, 1731, 1733 within the respective chamber or enclosed portion 1701, 1702, 1703. The controller 1740 will selectively move the colorant or dye 1730, 1731, 1733 in each of the chambers or enclosed portions 1701, 1702, 1703 to produce filtered light of a particular color. In one embodiment, each of the chambers or enclosed portions 1701, 1702, 1703 include a different color. In one example embodiment, the first color, the second color, and the third color associated with the chambers or enclosed portions 1701, 1702, 1703 include cyan, yellow, and magenta.

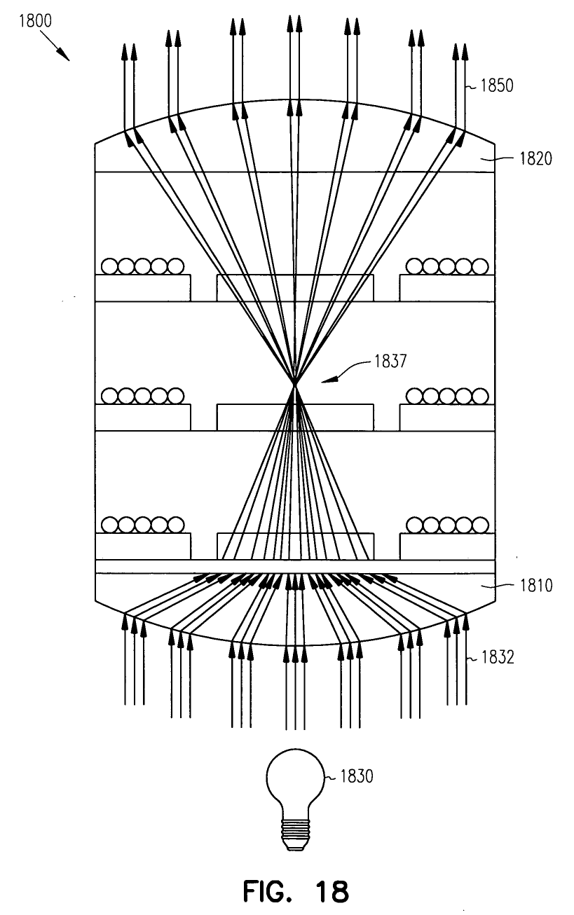

FIG. 18 is a schematic diagram of a stack of enclosed portions forming a cell 1800 of a spatial light generator of a display device 100 (shown in FIG. 1), according to another example embodiment. The cell 1800 includes a stack 1700 of chambers or enclosure portions. The cell 1800 also includes a first lens 1810 on the end of the stack 1700 and a second lens 1820 on the other end of the stack 1700. In one embodiment, the lens 1810 is a micro lens array that includes transparent traces and transparent transistor logic. Lens 1820 is a similar micro lens array. Light from a light source 1830, is directed along a plurality of light paths, such as light path 1832, through the stack 1700 of chambers or enclosure portions. The lens 1830 can be used to change a focal point 1837 of the various light paths, such as light path 1832. The controller 1740 (shown in FIG. 17) acts upon image data and signals to move the different colored colorants within the different cells into and out of the light paths, such as light path 1832. The focal point can be changed to vary the amount of colorant used to filter the light along a light path. As shown in FIG. 18, the focal point is placed near an inner electrode that allows the light to pass through the chamber or enclosure portion without moving a colorant into the light path. The light passing through the cell 1800 then exits from the cell as filtered light 1850 or in some instances, unfiltered light.

Referring now to FIGS. 1, 17 and 18, a display device 100 includes a plurality of display elements, such as cell 1800, capable of controlling light within a visible light spectrum. The plurality of display elements, such as cell 1800, are positioned over a display surface of the display. The source of light 1830 produces a light path, such as light path 1832. At least some of the display elements, such as cell 1800, include a first chamber 1701 and a second chamber 1702. The first chamber 1701 further includes a first colorant 1730, and an apparatus for controlling the position of the first colorant with respect to the light path 1740. The second chamber 1702 includes a second colorant 1731, and an apparatus for controlling the position of the second colorant with respect to the light path 1740. The light path passes through the first chamber 1701 and the second chamber 1702. The display 100 also includes a plurality of receivers, such as receiver 1760, coupled to the plurality of display elements, such as 1700, and adapted to receive transmitted image information and activate the display elements in response to the image information. The display further includes an apparatus for controlling the first chamber 1701 and the second chamber 1702. The apparatus controls at least some of the chambers 1701, 1702 in at least one of the display elements, such as cell 1700, in response to image information received at the receivers. The display further includes a third chamber 1703 having a third colorant 1733, and an apparatus for controlling the position of the third colorant 1733 with respect to the light path 1832. In some embodiments, the first chamber 1701, the second chamber 1702, and the third chamber 1703 are stacked with respect to one another. The display 100 includes a plurality of receivers coupled to the plurality of display elements. The receivers are adapted to receive transmitted image information and activate the display elements in response to the image information. Each of the display elements has a refresh rate that enables motion video and video motion with temporally dithered color depth. At least one receiver includes control lines for controlling the first position of the first colorant 1730, for controlling the position of the second colorant 1731, and for controlling the third colorant 1733, in response to image information received at the at least one receiver. It should be noted that the colorant need not be within the visible range. The colorant could also allow only selected frequencies of other light or radiation to pass an individual cell.

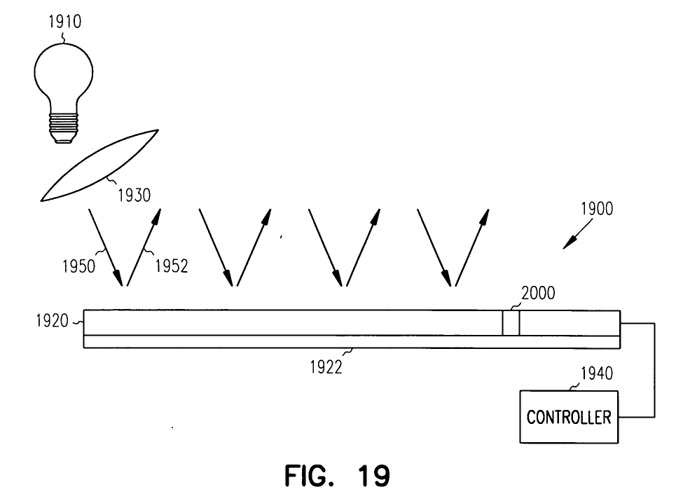

FIG. 19 is a schematic diagram of a display device 1900, according to an example embodiment. The display device 1900 includes a light source 1910, optics 1930, and a spatial light modulator 1920. The spatial light modulator 1920 includes a reflector or reflective surface 1922 which is attached or placed adjacent the spatial light modulator 1920. The optics 1930 direct white, incident light 1950 toward the spatial light modulator 1920. The light is transmitted through the spatial light modulator 1920 to the reflector or reflective surface 1922 and then is reflected as filtered light 1952 from the spatial light modulator 1920. The reflective surface 1922 may also be a reflective backing. The spatial light modulator 1920 also includes at least one cell 2000 or pixel. In some embodiments, the spatial light modulator 1920 includes a plurality or multiplicity of cells or pixels 2000. A controller 1940 is also attached to the spatial light modulator 1920. Specifically, the controller 1940 receives image information and outputs it to the spatial light modulator 1920 so that images are produced on the spatial light modulator. More specifically, the controller 1940 is connected to one or more of the cells or pixels. The controller 1940 controls the individual cells or pixels to produce a desired image which can be either viewed directly by looking at the surface of the spatial light modulator 1920 or projected onto a screen (not shown). It should be noted that the spatial light modulator 1920 can be made up of a single cell 2000 or a multiplicity or plurality of cells 2000. In some embodiments, the light source is incident or available light rather than a separate light source as shown in FIG. 19.

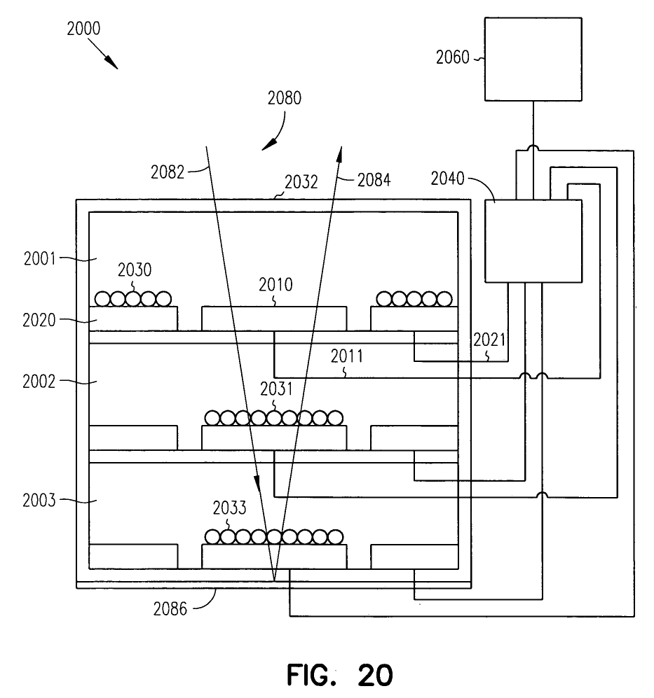

FIG. 20 is a schematic diagram of a stack 2000 of chambers or enclosed portions 2001, 2002, 2003, according to an example embodiment. Each of the chambers or enclosed portions 2001, 2002, 2003 has substantially the same structure. As a result, rather than be repetitive, one of the chambers or enclosed portions 2001 will be described from a structural standpoint for the sake of brevity. Chamber or enclosed portion 2001 includes an inner electrode 2010 and an outer electrode 2020. The inner electrode is an electrode that is positioned in a light path. The outer electrode is an electrode within the chamber that is outside the light path. The chamber 2001 also includes an electrical trace or conductor 2011 for electrically connecting the inner electrode 2010 to a controller 2040. The chamber 2001 also includes an electrical trace or conductor 2021 for electrically connecting the outer electrode 2020 to a controller 2040. The chamber or enclosed portion 2001 also includes a fluid that includes both a transparent or translucent portion 2032 and a colorant or dye 2030. The controller 2040 controls the charge on both the inner electrode 2010 and the outer electrode 2020. This in turn controls the position of the colorant or dye 2030. As shown in chamber or enclosed portion 2001 in FIG. 20, the controller 2040 is controlling the voltage on the inner electrode 2010 and on the outer electrode 2020 so that the colorant 2030 is positioned on the outer electrode 2020. The display 1900 also includes a plurality of receivers, such as receiver 2060, coupled to the plurality of display elements and adapted to receive transmitted image information and activate the display elements in response to the image information.

Each of the chambers or enclosed portions 2001, 2002, 2003 includes a dye or colorant 2030, 2031, 2033, respectively. In one embodiment, the difference is that each of the chambers or enclosed portions 2001, 2002, 2003 includes a colorant, such as a pigment or dye, 2030, 2031, 2033 of a different color. In addition, the position of the colorant or dye 2030, 2031, 2033 within each of the chambers or enclosed portions 2001, 2002, 2003, respectively, is independently controllable by the controller 2040. In other words, the controller 2040 can be used to control the location of the colorant 2030, 2031, 2033 separately in each of the respective chambers or enclosed portions 2001, 2002, 2003. The controller 2040 can move any combination of the colorants 2030, 2031, 2033 into a light path 2080 to produce filtered light of a selected color. The light path 2080 includes an incident portion 2082 and a reflected portion 2084. The light is reflected by a reflective surface 2086 positioned adjacent the chamber 2003. It should also be noted that the colorants are not limited to use within the visible spectrum of colors but can also be employed for light outside the visible range. The controller 2040 will act in response to image data or image signals to control the movement of the colorant or dye 2030, 2031, 2033 within the respective chamber or enclosed portion-2001, 2002, 2003. The controller 2040 will selectively move the colorant or dye 2030, 2031, 2033 in each of the chambers or enclosed portions 2001, 2002, 2003 to produce filtered light of a particular color. In one example embodiment, the first color, the second color, and the third color associated with the chambers or enclosed portions 2001, 2002, 2003 include cyan, yellow, and magenta.

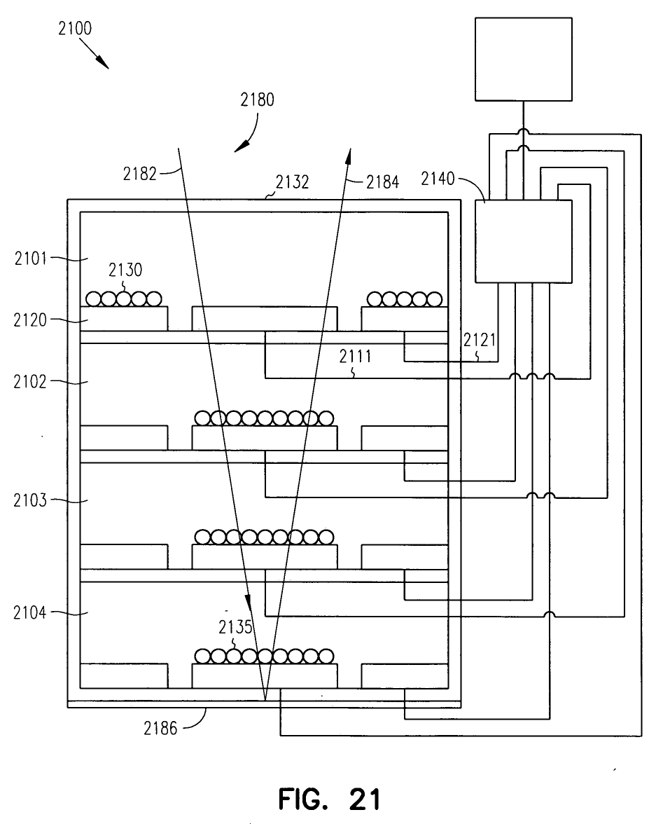

FIG. 21 is a schematic diagram of a stack 2100 of chambers or enclosed portions 2101, 2102, 2103, 2104 according to an example embodiment. Each of the chambers or enclosed portions 2101, 2102, 2103, 2104 has substantially the same structure. The structure of each of the chambers or portions is substantially the same as the structure of chamber 2001 described with respect to FIG. 20. The structure of the cell 2100 is similar to the structure of the cell 2000. Therefore, rather than explain the entire cell the differences will be discussed. Among the difference between FIG. 20 and FIG. 21, is the addition of a fourth cell or chamber 2104 with colorant 2135. In one embodiment, the colorant is black. Although black can be formed by moving all the colorants of chambers 2101, 2102, 2103 into a light path 2182, 2184, the fourth chamber 2104 can provide a more complete black state, in some embodiments. The fourth chamber or enclosed portion 2104 includes an electrode positioned within a light path 2180 and another electrode positioned outside the light path 2180. The light path 2180 includes an incident portion 2182 and a reflected portion 2184. The light is reflected by a reflective surface 2186 positioned adjacent the chamber 2004. It should also be noted that the colorants are not limited to use within the visible spectrum of colors but can also be employed for light outside the visible range. The chamber 2104 is also provided with electrical connections between the electrodes and the controller 2140.

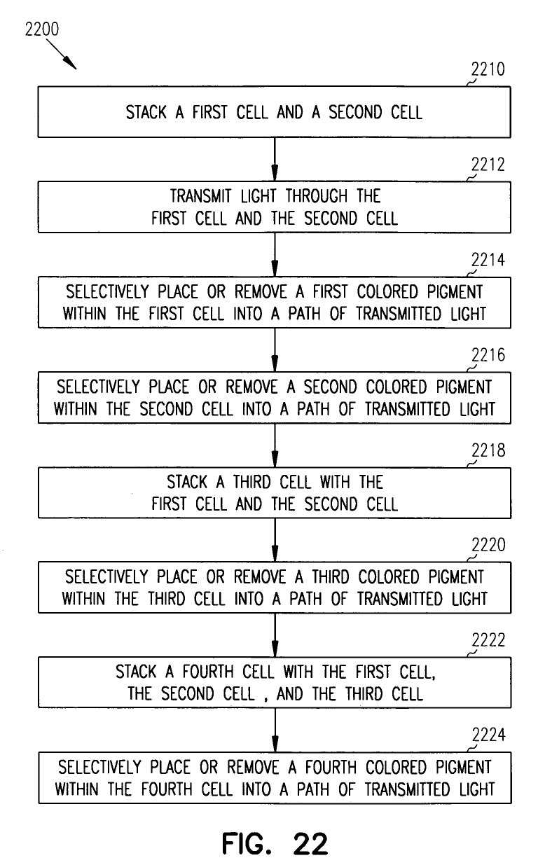

FIG. 22 is a flow diagram of a method 2200, according to an example embodiment. The method 2200 includes stacking a first cell and a second cell 2210, transmitting light through the first cell and the second cell 2212, selectively placing or removing a first colored colorant within the first cell into a path of the transmitted light 2214, and selectively placing or removing a second colored colorant within a second cell into the path of the transmitted light 2214. Selectively placing or removing a first colored colorant within the first cell into a path of the transmitted light includes applying an electromotive force to a portion of the first cell. Selectively placing or removing a second colored colorant within the second cell into a path of the transmitted light also includes applying an electromotive force to a portion of the second cell 2216.

In another embodiment, the method 2200 also includes stacking a third cell with the first cell and the second cell 2218, and transmitting light through the first cell, the second cell, and the third cell. A third colored colorant within the third cell is selectively placed into or removed from the path of the transmitted light 2220. Selectively placing or removing a third colored colorant within the third cell into a path of the transmitted light 2216 includes applying an electromotive force to a portion of the third cell. In still another embodiment, the method 2200 further includes stacking a fourth cell with the first cell, the second cell, and the third cell 2222, transmitting light through the first cell, the second cell, the third cell, and the fourth cell, and selectively placing or removing a fourth colored colorant within the fourth cell into a path of the transmitted light 2224. Selectively placing or removing a fourth colored colorant within the fourth cell into a path of the transmitted light 2224 includes applying an electromotive force to a portion of the fourth cell. In one embodiment, the first colored colorant, the second colored colorant, the third colored colorant and the fourth colored colorant include cyan, yellow, magenta and black. The colored colorant within the cells can be switched into and out of the light path with sufficient speed to provide video having a time frame greater than twenty frames per second. The colored colorant within the cells can be switched into and out of the light path with sufficient speed to provide color depth. A number of cells can be controlled within a display using a controller acting in response to image information received at receivers. The image information controls a portion of the plurality of display elements according to a controlled time sequence. The controlled time sequence is sufficient to provide video at a rate of greater than twenty five frames per second. The controlled time sequence includes refreshing a portion of the display elements to restore placement of colorants. Refreshing a portion of the display elements is accomplished at a frequency in the range of 25 Hz to 40 kHz.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various example embodiments. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments includes any other applications in which the above structures and methods are used. Therefore, the scope of various embodiments should be determined with reference to the appended claims, along with the full range of equivalents to which such claims are entitled.

1. A light modulator cell comprising:
a first enclosed portion that includes:
a first electrode resident within a light path;
a first electrode outside the light path;
a first colorant in communication with the first electrode resident within the light path and the first electrode outside the light path, the first electrode within the light path, the first electrode outside the light path, and the first colorant within the first enclosed portion; and
means for moving the first colorant between the first electrode within the light path and the first electrode outside the light path.

2. The light modulator of claim 1 wherein the first electrode within the light path is substantially rectangular.

3. The light modulator of claim 1 wherein the first electrode outside the light path is positioned near an outer periphery of the first electrode within the light path.

4. The light modulator of claim 1 further comprising a transmissive back plane.

5. The light modulator of claim 1 further comprising a reflective back plane.

6. The light modulator of claim 1 further comprising a light source for transmission of light substantially through the light modulator.

7. The light modulator of claim 1 wherein means for moving the first colorant includes an electrostatic system.

8. The light modulator of claim 1 wherein means for moving the first colorant includes an electrophoresis system.

10. The light modulator of claim 1 wherein means for moving the first colorant includes an electrowetting system.

11. A light modulator comprising:
a first enclosed portion
a second enclosed portion, wherein each of the first enclosed portion and the second enclosed portion include:
an electrode resident within a light path; and
an electrode outside the light path;
a first colorant in the first enclosed portion, the first colorant in communication with the electrode resident within the light path and the electrode outside the light path;
a second colorant in the second enclosed portion, the second colorant in communication with the electrode resident within the light path and the electrode outside the light path
means for moving the first colorant within the first enclosed portion between the electrode within the light path and the electrode outside the light path; and
means for moving the second colorant within the second enclosed portion between the electrode within the light path and the electrode outside the light path.

12. The light modulator of claim 11 wherein the first enclosed portion is stacked on the second enclosed portion.

13. The light modulator of claim 11 further comprising a lens for directing light through the first enclosed portion and the second enclosed portion.

14. The light modulator of claim 13 further comprising a lens system adapted to transmit light through the electrode within the light path of the first enclosure and the electrode within the light path of the second enclosure.

15. The light modulator of claim 11 further comprising a reflector adapted to reflect light through the electrode within the light path of the first enclosure and the electrode within the light path of the second enclosure.

16. The light modulator of claim 11 further comprising a controller for selectively moving the first colorant between the electrode of the first enclosed portion within the light path and the electrode outside the light path, and for selectively moving the second colorant between the electrode of the second enclosed portion within the light path and the electrode outside the light path.

17. The light modulator of claim 11 further comprising:
a source of light; and
a lens positioned to direct light from the source of light through the first enclosed portion and the second enclosed portion.

18. The light modulator of claim 111 further comprising:
a third enclosed portion that includes:
an electrode resident within a light path; and
an electrode outside the light path;
a third colorant in the third enclosed portion, the third colorant in communication with the electrode resident within the light path and the electrode outside the light path; and
means for moving the third colorant within the third enclosed portion between the electrode within the light path and the electrode outside the light path

19. The spatial light modulator of claim 18 further comprising:
a fourth enclosed portion that includes:
an electrode resident within a light path; and
an electrode outside the light path;
a fourth colorant in the fourth enclosed portion, the fourth colorant in communication with the electrode resident within the light path and the electrode outside the light path; and
means for moving the fourth colorant within the fourth enclosed portion between the electrode within the light path and the electrode outside the light path.

20. A method comprising:
stacking a first cell and a second cell;
transmitting light through the stacked first and second cell;
selectively moving a first colorant within the first cell into a path of the transmitted light and out of the path of transmitted light; and
selectively moving a second colorant within a second cell into the path of the transmitted light and out of the path of transmitted light.

21. The method of claim 20 wherein selectively moving a first colorant within the first cell into a path of the transmitted light and out of the path of transmitted light includes applying an electromotive force to a portion of the first cell.

22. The method of claim 20 wherein selectively moving a first colorant within the first cell into a path of the transmitted light and out of the path of transmitted light includes removing an electromotive force.

23. The method of claim 20 wherein selectively moving a first colored colorant within the first cell into a path of the transmitted light and out of the path of transmitted light includes applying and removing an electromotive force selectively according to a controlled time sequence.

24. The method of claim 23 wherein the time sequence rate is sufficient to provide video at a rate of greater than twenty five frames per second.

25. The method of claim 23 wherein the time sequence rate is sufficient to portray color depth.

26. The method of claim 23 wherein the electromotive force is varied sufficiently to produce analog color depth.

27. The method of claim 20 wherein selectively moving a second colorant within the second cell includes applying an electromotive force to a portion of the second cell.

28. The method of claim 20 further comprising:
stacking a third cell with the first cell and the second cell;
transmitting light through the first cell, the second cell, and the third cell;
selectively moving a third colorant within the third cell into the path of the transmitted light and outside the path of the transmitted light.

29. The method of claim 28 further comprising:
stacking a fourth cell with the first cell, the second cell, and the third cell;
transmitting light through the first cell, the second cell, the third cell, and the fourth cell; and
selectively moving a fourth colorant within the fourth cell into the path of the transmitted light and outside the path of the transmitted light.

30. The method of claim 29 wherein the first colorant, the second colorant, the third colorant and the fourth colored colorant include cyan, yellow, magenta and black.

31. A display device comprising:
a source of light that produces a light path
a plurality of display elements capable of controlling light, the plurality of display elements positioned over a surface of the display, at least some of the display elements further comprising:
a first cell further including
a first colorant; and
means for controlling the position of the first colorant with respect to the light path; and
a second cell further including:
a second colorant; and
means for controlling the position of the second colorant with respect to the light path, wherein the light path passes through the first cell and the second cell.

32. The display device of claim 31 wherein the light is in a visible light spectrum.

33. The display device of claim 31 wherein the first cell is in an adjacent plane with respect to the second cell.

34. The display of claim 31 further comprising a plurality of receivers coupled to the plurality of display elements and adapted to receive transmitted image information and activate the display elements in response to the image information.

35. The display of claim 34 wherein the image information controls a portion of the plurality of display elements according to a controlled time sequence.

36. The display of claim 35 wherein the controlled time sequence is sufficient to provide video at a rate of greater than twenty five frames per second

37. The display of claim 36 wherein the controlled time sequence includes refreshing a portion of the display elements to restore placement of colorants.

38. The display of claim 37 wherein refreshing a portion of the display elements is accomplished at a frequency in the range of 25 Hz to 40 kHz.

39. The display of claim 31 further comprising:
a third cell further including
a third colorant; and
means for controlling the position of the third colorant with respect to the light path.

40. The display of claim 39 further comprising:
a fourth cell further including:
a fourth colorant; and
means for controlling the position of the fourth colorant with respect to the light path.

41. The display device of claim 40 wherein the first cell, the second cell, the third cell and the fourth cell are stacked with respect to one another.

42. The display of claim 40 further comprising a plurality of receivers coupled to the plurality of display elements and adapted to receive transmitted image information and activate the display elements in response to the image information.

43. A method comprising:
transmitting light through a cell; and
selectively moving a colorant within the cell into a path of the transmitted light and out of the path of transmitted light.

44. The method of claim 43 wherein selectively moving a colorant within the first cell into a path of the transmitted light and out of the path of transmitted light includes applying an electromotive force to a portion of the cell.

45. The method of claim 43 wherein selectively moving a colorant within the cell into a path of the transmitted light and out of the path of transmitted light includes removing an electromotive force.

46. The method of claim 43 wherein selectively moving a colored colorant within the cell into a path of the transmitted light and out of the path of transmitted light includes applying and removing an electromotive force selectively according to a controlled time sequence.

47. A method of forming a light modulator comprising:
forming an inner electrode and an outer electrode on one of a lid or a cup of a first cell;
forming an inner electrode and an outer electrode on one of a lid or a cup of a second cell;
filling the cup of the first cell with a first liquid and a first colorant;
sealing the lid and the cup of the first cell;
filling the cup of the second cell with a second liquid and a second colorant; and
sealing the lid and the cup of the second cell; and
stacking the first cell and the second cell.

48. The method of claim 47 further comprising passing light through a portion of the first cell and the second cell.

49. The method of claim 48 further comprising:
moving the colorant in the first cell between a position within a light path of the light passing through the first cell and outside the light path of the light passing through the first cell; and
moving the colorant in the second cell between a position within a light path of the light passing through the second cell and outside the light path of the light passing through the second cell.

50. The method of claim 49 wherein moving the colorant in the first cell between a position within a light path of the light passing through the first cell and outside the light path of the light passing through the first cell includes controlling a charge on the inner electrode and controlling a charge on the outer electrode of the first cell.
